(19) United States
(12) Patent Application Publication
(10) Pub. No.: US 2026/0135860 A1
(43) Pub. Date: May 14, 2026

(54) Security Systems and Methods Dynamically Generating Payload Schema Processing Code Using Machine Learning Techniques

(71) Applicant: WitnessAI, Inc., San Mateo, CA (US)

(72) Inventors: Gil Spencer, Incline Village, NV (US); Mathew Solnik, Dallas, TX (US); Amr A. Ali, Cairo (EG); Muhammed Abdel Hamid, Edison, NJ (US); Ahmed Ewais, Cairo (EG)

(21) Appl. No.: 18/942,517

(22) Filed: Nov. 9, 2024

(51) Int. Cl. H04L 9/40; G06F 40/205

(52) U.S. Cl. CPC H04L 63/1416; G06F 40/205; H04L 63/1433

(57) ABSTRACT

A processor may capture network packets from a communication channel between a user and an application, the network packets comprising a data structure package. A processor may identify a schema of a payload used in the data structure package of the network packets. A processor may dynamically generate payload schema processing code using a machine learning dynamic protocol parser by applying a machine learning model to the schema of the payload, the payload schema processing code including a description of each field of the data structure package and a parser function for extracting a prompt. A processor may iterate the dynamically generating of the payload schema processing code until the payload schema processing code meets a predefined accuracy and functionality criteria that successfully extracts the prompt.

### CROSS REFERENCE TO RELATED APPLICATIONS

This patent application is related to U.S. patent application Ser. No. 18/622,686 filed on Mar. 29, 2024 and titled “Secure Systems of Guardrails for Securing the Use of Large Language Models (LLMS)”. This patent application is also related to U.S. patent application Ser. No. 18/829,021 filed on Sep. 9, 2024 and titled “Methods and Systems for Security Enhancement in Artificial Intelligence Model Interactions via Automated Injection and Proxy Server Implementation”. The aforementioned applications are hereby incorporated by reference in their entireties including all references for all purposes.

### FIELD OF THE TECHNOLOGY

The present technology relates to network security, specifically to methods and systems for detecting and responding to network threats using machine learning models and dynamically generating payload schema processing code using machine learning techniques.

### BACKGROUND

The approaches described in this section could be pursued, but are not necessarily approaches that have previously been conceived or pursued. Therefore, unless otherwise indicated, it should not be assumed that any of the approaches described in this section qualify as prior art merely by virtue of their inclusion in this section.

Previous approaches to dynamically generating payload schema processing code for network packets have typically involved static methods that rely on predefined rules or templates to extract and interpret data structures. These static methods often lack the flexibility to adapt to evolving network threats and changing data structures, leading to potential vulnerabilities and inefficiencies in threat detection and response. Additionally, the manual creation and maintenance of payload schema processing code based on fixed rules can be time-consuming and error-prone, especially in complex network environments where data structures may vary significantly.

In existing systems, network threat detection and response mechanisms have traditionally been based on signature-based detection techniques or rule-based systems that are limited in their ability to detect novel or sophisticated threats. These conventional methods may struggle to keep pace with the rapidly evolving landscape of cybersecurity threats, particularly in scenarios where attackers employ advanced evasion techniques. Furthermore, the deployment of security code in response to detected threats has often been a manual and reactive process, requiring human intervention to analyze and mitigate security incidents, which can introduce delays and increase the risk of successful attacks.

Efforts to enhance the automation and intelligence of network security operations have led to the integration of machine learning techniques into threat detection and response systems. Machine learning models offer the potential to analyze network traffic patterns, identify anomalies, and predict potential threats in real-time, enabling proactive security measures. However, the application of machine learning in the context of dynamically generating payload schema processing code and deploying security measures in response to network threats remains an ongoing challenge in the field of cybersecurity. However, none of these approaches have provided a comprehensive solution that combines the features described in this disclosure.

### SUMMARY

Some embodiments of the present technology, relate to a computer-implemented method for dynamically generating payload schema processing code using machine learning, the method including: capturing network packets from a communication channel between a user and an application, the network packets including a data structure package; identifying a schema of a payload used in the data structure package of the network packets; dynamically generating payload schema processing code using a machine learning dynamic protocol parser by applying a machine learning model to the schema of the payload, the payload schema processing code including a description of each field of the data structure package and a parser function for extracting a prompt; and iterating the dynamically generating of the payload schema processing code until the payload schema processing code meets a predefined accuracy and functionality criteria.

In some embodiments, the techniques described herein relate to a computer-implemented method, wherein the capturing network packets includes intercepting the network packets using a proxy server positioned between the user and the application, the application being an Large Language Model (LLM) integrated application using an external Application Programing Interfaces (API) provided by an LLM provider.

In some embodiments, the techniques described herein relate to a computer-implemented method, wherein the proxy server uses deep packet inspection (DPI) techniques to capture detailed information from the network packets.

In some embodiments, the techniques described herein relate to a computer-implemented method, wherein the predefined accuracy and functionality criteria include successfully extracting the prompt from the network packets.

In some embodiments, the techniques described herein relate to a computer-implemented method, wherein the machine learning model is a large language model (LLM) trained to analyze the network packets and generate parser functions.

In some embodiments, the techniques described herein relate to a computer-implemented method, wherein the dynamically generating payload schema processing code using the machine learning dynamic protocol parser includes generating a plurality of fields of the data structure package and a parser function for extracting the prompt.

In some embodiments, the techniques described herein relate to a computer-implemented method, wherein the data structure package is an uninterrupted input in JSON format.

In some embodiments, the techniques described herein relate to a computer-implemented method, wherein the iterating the dynamically generating of the payload schema processing code until the payload schema processing code meets the predefined accuracy and functionality criteria is an iterative self-correction mechanism, the iterative self-correction mechanism refining the generated payload schema processing code until the prompt is extracted.

In some embodiments, the techniques described herein relate to a computer-implemented method, wherein the predefined accuracy and functionality criteria include correctly parsing and extracting specific fields from the data structure package.

In some embodiments, the techniques described herein relate to a computer-implemented method, wherein the machine learning model uses natural language processing (NLP) techniques to analyze the data structure package and generate the payload schema processing code.

In some embodiments, the techniques described herein relate to a computer-implemented method, wherein the machine learning model is configured to detect zero-day vulnerabilities by training the machine learning model on previous known vulnerabilities and creating a separate offensive machine learning model that generates vulnerabilities that are used as synthetic training data.

In some embodiments, the techniques described herein relate to a computer-implemented method, wherein the generated payload schema processing code is deployed in a sandbox environment for testing before being deployed.

In some embodiments, the techniques described herein relate to a computer-implemented method, wherein the machine learning model generates an alert, the alert being when a network threat is detected.

In some embodiments, the techniques described herein relate to a computer-implemented method, further including testing the generated payload schema processing code against a set of known network packets to verify accuracy and functionality.

In some embodiments, the techniques described herein relate to a computer-implemented method, wherein the machine learning model iteratively self-corrects the generated payload schema processing code based on feedback from testing results.

In some embodiments, the techniques described herein relate to a computer-implemented method, further including detecting a network threat in real-time by analyzing the data structure package using a machine learning model.

In some embodiments, the techniques described herein relate to a computer-implemented method, further including responding to the detected network threat by generating and deploying security code using the machine learning model, the security code using the machine learning dynamic protocol parser.

In some embodiments, the techniques described herein relate to a computer-implemented method for dynamically generating payload schema processing code using machine learning, the method including: capturing network packets from a communication channel between a user and an application, the network packets including a data structure package; identifying a schema of a payload used in the data structure package of the network packets; dynamically generating payload schema processing code using a machine learning dynamic protocol parser by applying a machine learning model to the schema of the payload, the payload schema processing code including a description of each field of the data structure package and a parser function for extracting a prompt; and iterating the dynamically generating of the payload schema processing code until the payload schema processing code meets a predefined accuracy and functionality criteria, the predefined accuracy and functionality criteria include successfully extracting the prompt from the network packets.

In some embodiments, the techniques described herein relate to a computer-implemented method for dynamically generating payload schema processing code using machine learning, the method including: receiving network packets using a proxy server between external Application Programing Interface (API) of a Large Language Model (LLM) integrated application and a prompt filter, the network packets including a data structure package; receiving a failure response from a predefined static protocol parser, the predefined static protocol parser generating the failure response after failing to process the data structure package; dynamically generating payload schema processing code using a machine learning dynamic protocol parser by applying a machine learning model to the data structure package, the payload schema processing code including a description of each field of the data structure package and a parser function for extracting a prompt; iterating the dynamically generating of the payload schema processing code using the machine learning dynamic protocol parser until the payload schema processing code meets a predefined accuracy and functionality criteria, the predefined accuracy and functionality criteria including successfully extracting the prompt from the network packets; and deploying the payload schema processing code to maintain functionality of the LLM integrated application.

In some embodiments, the techniques described herein relate to a computer-implemented method, wherein the machine learning model iteratively self-corrects the generated payload schema processing code based on feedback from testing results.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates a high-level block diagram of an exemplary environment using a proxy server that is configured for dynamically generating payload schema processing code using machine learning, according to embodiments of the present technology.

FIG. 2 depicts a process flow diagram for dynamically generating payload schema processing code using machine learning, according to embodiments of the present technology.

FIG. 3 depicts another process flow diagram for dynamically generating payload schema processing code using machine learning, according to embodiments of the present technology.

FIG. 4 illustrates an exemplary computer system that may be used to implement security methods for dynamically generating payload schema processing code using machine learning, according to embodiments of the present technology.

### DETAILED DESCRIPTION OF EXEMPLARY EMBODIMENTS

In the following description, for purposes of explanation, numerous specific details are set forth in order to provide a thorough understanding of the disclosure. It will be apparent, however, to one skilled in the art, that the disclosure may be practiced without these specific details. In other instances, structures and devices may be shown in block diagram form only in order to avoid obscuring the disclosure. It should be understood, that the disclosed embodiments are merely exemplary of the invention, which may be embodied in multiple forms. Those details disclosed herein are not to be interpreted in any form as limiting, but as the basis for the claims.

In various embodiments of the present technology a proxy server is used to enable the secure use of Artificial Intelligence (AI) by using Large Language Model (LLM) integrated applications. For example, LLM integrated applications include code completion and automatic programming tools (e.g., GitHub Copilot), generative artificial intelligence chatbots (e.g., Microsoft 365 Copilot), AI code editors (e.g., Cursor), and many others. These LLM integrated applications use external Application Programing Interfaces (APIs) provided by an LLM provider such as ChatGPT. A proxy server of the present technology works as the middleware between prompt filters and public LLM interfaces (e.g., external APIs). Functionality of the proxy server of the present technology needs parsing of the response data structure (e.g., JavaScript Object Notation (JSON)) response) from the external APIs. However, due to changes/updates in fields (e.g., JSON fields) from the external APIs (i.e., LLM-provider's side), a predefined static protocol parser is not sufficient as there is a mismatch between the response data structure and the definition. To solve this problem, the present technology uses a novel Machine Learning (ML) pipeline to act as an ML based dynamic protocol parser that detects in real-time the changes/updates in fields (e.g., JSON fields) from the response data structure (e.g., JSON response).

Various embodiments of the present technology include a dynamic protocol parser that is designed to as a Machine Learning (ML) based dynamic protocol parser. For example, the ML based dynamic protocol parser may act as a contingency in case when the predefined static protocol parser does not find the predefined matched fields in the response data structure (e.g., JSON response) for extracting the prompt. For example, the ML based dynamic protocol parser uses dynamic protocol parsing that includes a parser language model. The parser language model may be tuned to accurately detect the necessary fields in the response data structure (e.g., JSON response) from the external APIs. For example, the parser language model may produce artifacts including a description for each field in the response data structure (e.g., JSON response) and a parser function (e.g., Python function) that parses the response data structure (e.g., JSON response) and produces the required fields to extract a prompt. In some embodiments, an iterative self-correction mechanism is used to reinforce the accuracy of the parser language model.

In the realm of network security, the rapid evolution of cybersecurity threats poses significant challenges to existing systems. Traditional methods for detecting and responding to network threats often rely on static techniques, such as signature-based detection and rule-based systems. These approaches may struggle to keep pace with the dynamic nature of modern threats, particularly when attackers employ advanced evasion techniques or polymorphic malware. The need for more adaptive and intelligent security measures has become increasingly apparent as the landscape of cybersecurity continues to evolve.

Existing solutions for generating payload schema processing code typically involve static methods that depend on predefined rules or templates to extract and interpret data structures. These static methods lack the flexibility to adapt to changes in data structures, leading to potential vulnerabilities and inefficiencies in threat detection and response. The manual creation and maintenance of payload schema processing code based on fixed rules can be time-consuming and error-prone, especially in complex network environments where data structures may vary significantly. Furthermore, the deployment of security code in response to detected threats has often been a manual and reactive process, requiring human intervention to analyze and mitigate security incidents, which can introduce delays and increase the risk of successful attacks.

In various embodiments, the present technology introduces a novel approach to network security by leveraging machine learning techniques to dynamically generate payload schema processing code. This method captures network packets from a communication channel between a user and an application, utilizing a proxy server to intercept and analyze the data structure package. By applying a machine learning model, the system identifies the schema of the payload and dynamically generates payload schema processing code, including a description of each field and a parser function for extracting prompts. The process iterates until the generated code meets predefined accuracy and functionality criteria, ensuring adaptability to changes in data structures without manual intervention. Additionally, the system responds to detected network threats by generating and deploying security code, enhancing the overall security posture of the application.

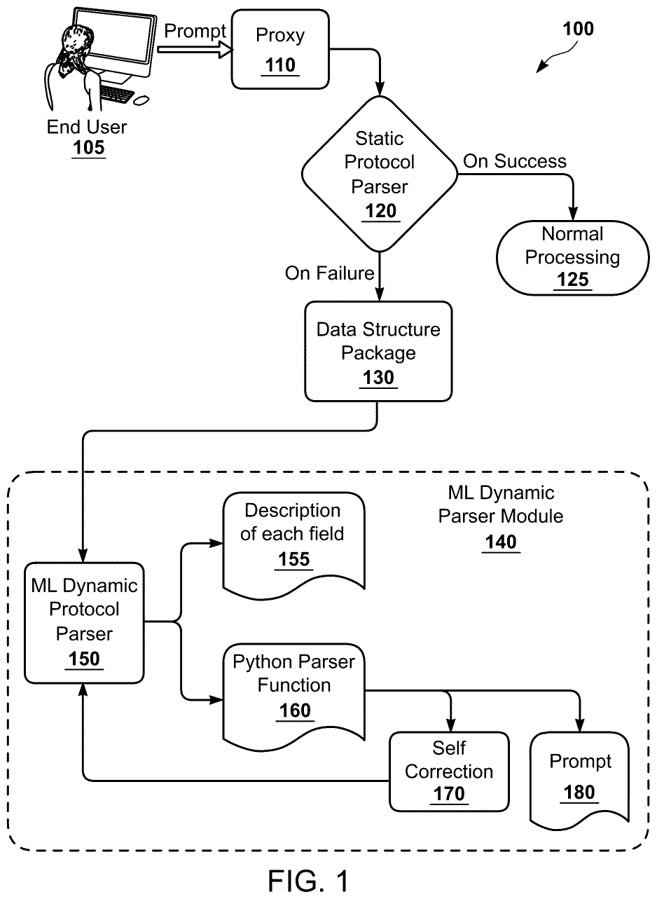

FIG. 1 illustrates a high-level block diagram of an exemplary environment using a proxy server 110 that is configured for dynamically generating payload schema processing code using machine learning, according to embodiments of the present technology. FIG. 1 illustrates a system architecture for processing and parsing data, with exemplary handling both static and dynamic parsing scenarios. The flow begins with a proxy server 110 receiving a prompt data from a user 105. The proxy server 110 may receive network packets using the proxy server 110 between external Application Programing Interface (API) of a Large Language Model (LLM) integrated application and a prompt filter, the network packets comprising a data structure package. The proxy server 110 may then attempt to process the prompt data using a predefined static protocol parser 120. If this static parsing using the predefined static protocol parser 120 is successful, the flow proceeds to normal processing 125 of the prompt. However, if the static parsing fails using the predefined static protocol parser 120, the system of the present technology employs a machine learning (ML) dynamic parser module 140 using a machine learning (ML) dynamic protocol parser 150, as shown by the machine learning (ML) dynamic parser module 140.

According to various embodiments of the present technology machine learning (ML) dynamic parser module 140 may receive a failure response from the predefined static protocol parser 120. For example, a failure response may include a failure message of the predefined static protocol parser 120 that may be the data structure package 130. For example, the data structure package 130 may be an uninterpreted JSON input. The data structure package 130 is received by the machine learning dynamic protocol parser 150 (e.g., a parser language model (LM)). The machine learning dynamic protocol parser 150 may generate outputs including a first output comprising a description for each field 155 in the data structure package 130 (e.g., the uninterpreted input JSON). The machine learning dynamic protocol parser 150 outputs may further comprise a second output including a Python parser function 160. The dynamic protocol parser 150 output including the Python parser function 160 may iterative undergo a self-correction process 170, which loops back to the machine learning dynamic protocol parser 150 for refinement. The Python parser function 160 may generate the prompt 180. FIG. 1 illustrates effectively illustrates a mechanism where, if traditional static parsing fails (e.g., static protocol parser 120 fails), a more flexible machine learning-based approach based on the machine learning dynamic parser module 140 using the dynamic protocol parser 150 to interpret and process the data structure package 130 dynamically. For example, adapting to changes in data structures without manual intervention is enabled by the machine learning dynamic parser module 140.

In various embodiments, the machine learning dynamic parser module 140 including the machine learning dynamic protocol parser 150 is a system designed to interpret and extract necessary fields from data structures (e.g., data structure package 130), such as JSON, in real-time, adapting to changes without manual intervention. The machine learning dynamic protocol parser 150 uses machine learning models to identify and parse altered data fields, ensuring accurate data processing even when the data format changes unexpectedly.

In various embodiments, features of the machine learning dynamic protocol parser 150 comprise adaptability by automatically adjusting to changes in data structures (e.g., data structure package 130), such as JSON fields, without requiring predefined rules. The machine learning dynamic protocol parser 150 comprises machine learning integration and utilizes a parser language model to detect and describe necessary fields (e.g., description for each field 155) of the input data (e.g., data structure package 130). The machine learning dynamic protocol parser 150 further comprises an iterative self-correction (e.g., the self-correction process 170) that incorporates a feedback loop to refine parsing accuracy and functionality over time. The machine learning dynamic protocol parser 150 further includes real-time processing and is capable of processing data in real-time, making the machine learning dynamic parser module 140 including the machine learning dynamic protocol parser 150 suitable for applications that require immediate response and analysis. The machine learning dynamic protocol parser 150 is particularly useful in environments where data formats are frequently updated, such as APIs provided by large language model (LLM) providers, ensuring seamless and secure data communication.

Embodiments of the present technology include capturing network packets from a communication channel between a user and an application using a proxy server 110, the network packets comprising a data structure package 130. In some embodiments, the data structure package 130 is an uninterrupted input in JSON format receiving. For example, an exemplary uninterpreted JSON input according to some embodiments of the present technology is shown below.

```
{
  “Request”: {
“Headers”: “Host: www.office.com\r\nCookie:
OH.FLID-09a0c706-bb46-4507-a340-534839523aaa;
MUID=1A797E4699E6676D295C6AEE986D6626;
MSFPC=GUID=9f4ad1013e7aff214685ca4929e953c0&HASH=9f4a&LV=202404&V=4&LU=
1712222570962;
OH.DCAffinity=OH-weu;
OhpToken=AQAAABowOS8yMS8yMDI0IDA5OjEzOjE1ICswMDowMOwHMC5BYWdBdW
puUGFXNmlvMFdZMmxBZGFheGQ5VnRFWlVmR01yQkpnLVlkazNaU2RzcW9BQWMuQ
WdBQkF3RUFBQUFwVHdKbXpYcWRSNEJOMm1paGVRTVlBZ0RzX3dVQTlQX3FrYXhv
N2s4dHFYb1JlWS1GS2dLMW5tTExCMU1oUjZ5SF9HRUFKTkcyZExUZk4zZE5xbHR0b00z
MWV2bTRtU01aOUsycG9iaTI2RFlBdzc4NWstbEVYOWlWVFA1ZklKMm5JX2tacnROeFhK
QmRuUEtZYTZ5ak9sVEtnYWNLRWJPR1JjUkhlSW54OG9HTWtvT2Q0OG9McjdZU05nX2
9qbXh2OEFkckhxb0Myeno1ejh2dm11UkVUb19ZVGpjMm1STi15aUc0RFJqMVBqMHlsdmt
WamFwOWdKd0ZBR25hcGZiTV81MkRiOGJ5cUlYUDhVOFcxX0ZtNVVWSGF0RkJxamZ1
OFRhWjVreTdmVFFtelVudDRxczFnMHNmM3FqTUZqZnRrZGVYTUVmNEZyd3lydnlScEN
SRndla3g5QmU5cm9KbVpraVVRWk1jZG90dnh5ZHhrNTlrRmJHM0pBWm9INHA1S1RBQ1
IwZnhtQ1M3WWJ6ZXFQRURtRDBUQkNTOWsxcWlndUVZemV0cXpUX1pBVUtWeEFPa
UdYa1dtck16WnAyRTFQcTdaMDdKTGVGd2ZiWk9KczJ4Z1NQcWw2ZGtuZFh2MUM1SW1
Qb3BiNnBPbng1cUJnNjEyLTVzeHhZbnpoQjEzckpHUWJjOWVDcUc1dTE1ZEVSdkIzVTV6
OVFxaDJmbXN1UE5EZU41X1pFRE5Nam1YeFZaOWo1aks5N3M4SHNxUGthWFlp;UserInd
ex=H4sIAAAAAAAAChWNOQ7CMBRETdgOwA0Q7Q%2BOd6eCBokeifp7E5FILOHcX9jF
G00xS0cI2VSOla75axVyxs8cw%2B09rUss5f40Uvd5mSf%2FyyWntfd53tbYiVEmgCpg4kX1K
OUodRu6KOsTtw4BmYogJHKwJiBIOgRl0cuQ5K4d7RsP%2FJZ4aD0dPGrhDaRkEgg3RHDI
OTimo00hRWFUq%2F0BkMuqqLYAAAA%3D;OhpAuth=xEJs_ku0fxVpjnyAvqCIgwEW_SP
KAWZdbmkmfH9Jobwl1FkAeez82xxgGrOLcLy5h7kVDVLjpFeDDQRin_h0DtgygacK8WVZt
dvrudh0LUaS-3zuj-D4pFp3LkZ7dnpsRomjPMv5KWt4K0nBsOHE1nTL8e1knJT4BfGvkGzVI
NIKufezPlfumz9DTIr7p-i9MCjnqBvft1QSXzxGa8IKBJvqh5ORCIL2oHZ1cxF8VorQSBeiRUIJ
bx9sNuEI78bb1Pf4vOrZWj6Hhu1tVa8W_UT8KAUT5ujJM4uEcK5H88h4kD7f_-
9C3jXTQaU8ghRY_6cMy0YGLsw6uZ8KA1e9RDrrNPI0vVjJb7VDw7rl0rnoU5LGPV_I1dxs0
STQkR4cJqRTU4ZwzFftf7bAPb-sKt7QDBDDPg3Ux7sDX3RESB8a7PjFMcwLTlHsYPkwC4h
VMuYSRV2BaAp86X49OqXX_PboscLX8Ws6wPOEBFHZoIb305Iket1OeMIe6WpFMR8cMp
qLnZRU4fkUj5LdgKWgtxOxF9X-NIFr-i0wkn4M4s8RDbsy9Ld8C6vQC8P3wkFlq8ghR9TUL
HHpyYpaU7OhWzXEU9BTgqWaBbSFCBnkmlpUrvhAILdS0KzqPcDIEGmbmxUWp5Vbmbr
F_p1rfmVTlIN0fBYNyEW4YfZmrF9UUMXrTM4-YZkf9wPPAskN6U09Dtzi9PHELTqr-
IG2N5h_4VAvAmy8DdbqVTmYOpIMzwMXXL-arGudv9xcoommUqkCSI_s_aEFX4BgjoTKp
QL1L6EKxY0npFa125G0Ls8NLB3Nb9vdCUPLQLH_Hl6SusgthUb9GAKUye7acG22NabAg
OX1FKBmj4R40NjCxpm9krYkWvw5xzcDSn1ZXPcPdne6FwTTmpH6gpYOcKx7qEv9d6V_Y
866yf6oziMCjAUpZDtBqmij0fc0iMSdVU2YKrPIB7EpnyaSCxmDHyPbX7lAs8ZJ4jCyFCdqr
LIyUy8JNo3HdlHG3J72OsXCfY40-r9hl4SDUCiOgawlGkBBUvQ5-1c1zUD9a_jTsAoo--
rL6L4uCa9ausRuzCPrmG-HHUt35ZPpKRyr9cjTnhRs8RcqiAUzkS6XWzPpxbphDs4vrvxM3W
bEmMonPzZ_-U8zYiRzf0E4f762gdSQXIZ0OLMu8qr5aZFsYQ7H-DfWgJY6cILDkAm7lnFC2
SErvqTn9I9RMm-q-4--7HSqLJ-4IY0TSJbzRGK9-Dy6SQHyq_u6SsF8QLFYT5iPedQUOD5Z
WTqT4fEhxkMTc4TaIv2diTGsKRQu27evQ3gINW4p6k3-zVj5gb-PYq2S2TQzSwmHHmbT1S
mC2iBQSwmoAwk7XmGtYzm8uB2g2uTu0kJcsUwjBv49K7x3Ho-agMcDeIP34AAThqP4_G3
7ry9e7xQZXa7J0xyaZ-Dvm4WJOBiDc4XQ_aZ9TMHH3-bEFi13LR1RxoWvVhie3s9qs0Zpsx
_3IdiBfwaFwDknXWJkZ3Hm_12XjVsz7ZQTFt249HJCZo32iQ0cqViM03h2U50v4jwvucm3C
5Qq3ip3DLMSpmfw48KvJyJ-vjw_RlSlMHziv7yJTM_j1sOcaiiW4X-fylp_ZrHMFfM2UYiDB5
qIL6yA5f410slzAZG5APwXrmhEySzEGsqs1JANPn7KnI-ARjiFniVXYFNT-a5fkDtBC4imxoh
I3ojQlML8xpCyel4rk3w-n36gLGd35UXARTTvhyuIHkWr5Uv9ytNVJxGSdQup2XJNxHhWhj
xkaVDrJ-wxyeJZsz2RMHqtse5rbbYI4kgr_c3JnpoDKzwOCMrS6vaYmmoU7PQ_rRZX8D9gN
wVk6bkmiyWGX-VJy_ynCESWHLzqh4_rNjtubIWD41JHToEoBe2kPJ0UrTWvEZZpKHgaPm
Rfa5s_-OxYfOWiY-9b0QYqf5MWYQuVqabZJePk_FagQ3GWCk-x5LZSFpB4uJ_HrP8piyHL
B9EcBwMjr4lgleMIXScNvmdOyfxGulI6y84JoQE3f5xhpSX0eTWgKuCa1sFM2vfXcDhenIpIc
anmFUQfJjsxmdu6f5RyxDOqR-TivCsT3-B-vAY13ArYK_zGAvyCSAAlUzfOazsXr53CzOHg
ACG8GJy4aGHylPcfgikj9Y-BxCX_d57HLRWhE4rOVWVk_UYkdPSTxPm_wuYB7sR7UaaK
SO5YamUewNqWUWA3flWNqbfs7xhxxGSW_E_o5CG_2ojOBp1K9tHzU7J5b_PPjfWfIftxn
mgKSxMO1sz8EZ55aU5m19kR7cqqapEZr-54oPVHOibi6xZUPDbD9748TWQfJtY3ZrNe-Na-
lBeN9M4qgu3MkYJg5zVBpiF6MCtOmkdZTQoaH3gfQraGDcToHkgMxp-5fsI7yeYvGjkzee5r
FAQVd-i_Ahr9lQAsZCfDXdEjsNsBIA-ekH7rXG-tx_RPJgUFjy4Qi_yP39pWZRYWw_FVG-
U3_EK30CMemRWWVOuCkP_xfRy4hmW89_DTVxnEWYBlObWdGpCOqtFm_cdHhW2ou
Nkrsr-U1n1Jamsd71OJS_nH5t6IWkj4rnW8GctPD9FJE7JC1391MN6Wc2LetTbVXNgN9cFBE
UlsHUUfzR6RPC52nE-xLtEZI2FoyPcNlZxwQ3nU0VdhfspWY354D1j_aZPujreC_pZmn4tvkN
weBEgfljCE8dHIB2fouQyeib5jbj6pBttPDKVSkF7OxlXa5pgOw9Q1JofYI3DH19xzvJMJYh2Z
0bqFmTBpXmZL0Ps2sv-PB2is2CQdAMrW4cNkbbB5b3jIVAxWUz1SuRVKS_Q_ZoEmhSF_{—}
2jkTC32lYL-eYpaMQlWX7lpzoe1_7Zpud0wco6a3SIt1fwMYf3ZBkpcXTjU9uxKyScNlhe6Ibf
5wKpGeJu90ulM53zxXqR4dzhNtBXsU;
AjaxSessionKey=1KKUGx7mu3IumExWa1j3%2BYxLWVQxfKXHsrUNdq%2F9ZxrFSterQe1
kgOeQKdzltuDEXDONjKo0XqoqWZ5PBcAn2A%3D%3D; userid=10032003901CBA47;
MicrosoftApplicationsTelemetryDeviceId=abead5c6-e843-460b-8f6b-5dba38b33860;
OH.SID=b1d4f105-b583-41c8-9589-3df12311003c;
PersonalizationCookie=Eq%2BozeootwvCsMIqxJNOXECmZx9y93XOMh9%2FGMvP7jmd7J
A5hlsRYiblk2VglYvNAlMMp3QufP2Dd0UdeZbsDcc46y8DGaeNeDMo6txbLu%2FrDvD4GB
T%2BucqHb2E0LlsgT%2FXD5vLbBYQhTWHCBhx5O9qKaapQkD6AgwhrBA3rCNv0E1rIS
whnuJ%2FYYMBe6JBIEmrkpe2s8t6dVk72d%2FeMRrUB6wa3TbwCzxJKDSQ42kJIZ7Y%2B
xzjIrczN4GH3KR9vp37UXUJZGpa9SCKI%2BYoYbSDkR3pOwcal%2FxVc6PhlrGBxH1
E%2FLLyCetFZwEEf%2BAEA\r\nSec-Ch-Ua:
\“Not/A)Brand\”;v=\“8\”,\“Chromium\”;v=\“126\”,\“Google Chrome\”;v=\“126\”\r\nX-
Officehome-Forceexternal: 1\r\nX-Officehome-Authtype:
OrgId\r\nX-Officehome-Authversion: 2.0\r\nSec-Ch-Ua-Mobile: ?0\r\nUser-Agent:Mozilla/5.0
(X11; Linux x86_64)AppleWebKit/537.36 (KHTML, like Gecko)Chrome/126.0.0.0
Safari/537.36\r\nX-Officehome-Userid: 10032003901CBA47\r\nAccept: application/json,
text/plain, */*\r\nX-Officehome-Tenantid:
69cf39ba-a26e-45a3-98da-501d69ac5df5\r\nX-Officehome-Correlationid:
efc27a78-cd48-4cb0-be49-a8fb01650b87\r\nSec-Ch-Ua-Platform:
\“Linux\”\r\nSec-Fetch-Site: same-origin\r\nSec-Fetch-Mode: cors\r\nSec-Fetch-Dest:
empty\r\nReferer: https://www.office.com/?auth=2\r\nAccept-Encoding:
gzip,deflate,br\r\nAccept-Language: en-US,en;q=0.9\r\nPriority: u=1, i”,
  “Body”: “”,
  “BodyLength”: 0,
  “Time”: “Jun 24, 2024, 10:49:00\u202fAM”,
  “Length”: 0,
  “Tool”: “Proxy”,
  “Complete”: true,
  “URL”: “https://www.office.com/api/adminpolicy?workload=officehome”,
  “Method”: “GET”,
  “Path”: “/api/adminpolicy”,
  “Query”: “workload=officehome”,
  “PathQuery”: “/api/adminpolicy?workload=officehome”,
  “Protocol”: “https”,
  “IsSSL”: true,
  “UsesCookieJar”: “Partially”,
  “Hostname”: “www.office.com”,
  “Host”: “https://www.office.com”,
  “Port”: 443,
  “ContentType”: “”,
  “RequestHttpVersion”: “www.office.com”,
  “Extension”: “”,
  “Referrer”: “https://www.office.com/?auth=2”,
  “HasParams”: true,
  “HasGetParam”: true,
  “HasPostParam”: false,
  “HasSentCookies”: true,
  “CookieString”: “OH.FLID-09a0c706-bb46-4507-a340-534839523aaa;
MUID=1A797E4699E6676D295C6AEE986D6626;
MSFPC=GUID=9f4ad1013e7aff214685ca4929e953c0&HASH=9f4a&LV=202404&V=4&LU=
1712222570962;
OH.DCAffinity=OH-weu;
OhpToken=AQAAABowOS8yMS8yMDI0IDA5OjEzOjE1ICswMDowMOwHMC5BYWdBdW
puUGFXNmlvMFdZMmxBZGFheGQ5VnRFWlVmR01yQkpnLVlkazNaU2RzcW9BQWMuQ
WdBQkF3RUFBQUFwVHdKbXpYcWRSNEJOMm1paGVRTVlBZ0RzX3dVQTlQX3FrYXhv
N2s4dHFYb1JlWS1GS2dLMW5tTExCMU1oUjZ5SF9HRUFKTkcyZExUZk4zZE5xbHR0b00z
MWV2bTRtU01aOUsycG9iaTI2RFlBdzc4NWstbEVYOWlWVFA1ZklKMm5JX2tacnROeFhK
QmRuUEtZYTZ5ak9sVEtnYWNLRWJPR1JjUkhlSW54OG9HTWtvseldlN2FKbmQzVUxLc3g
1Q3g3Wko0dFdpMS1RU2c%3D;
UserIndex=H4sIAAAAAAAAChWNOQ7CMBRETdgOwA0Q7Q%2BOd6eCBokeifp7E5FILO
HcX9jFG00xS0cI2VSOla75axVyxs8cw%2B09rUss5f40Uvd5mSf%2FyyWntfd53tbYiVEmgCp
g4kX1KOUodRu6KOsTtw4BmYogJHKwJiBIOgRl0cuQ5K4d7RsP%2FJZ4aD0dPGrhDaRkEg
g3RHDIOTimo00hRWFUq%2F0BkMuqqLYAAAA%3D;
OhpAuth=xEJs_ku0fxVpjnyAvqCIgwEW_SPKAWZdbmkmfH9Jobwl1FkAeez82xxgGrOLcLy5
h7kVDVLjpFeDDQRin_h0DtgygacK8WVZtdvrudh0LUaS-3zuj-D4pFp3LkZ7dnpsRomjPMv5
KWt4KH0ZExGfVUwB3mfGvjhaua3SlFJoXJFTHOZjF036OTlAe99lSjA1J_C_kQjWWnn7tR
QjWJGe_N7R-pRC1pTa0Hl1qeoLDkiqA5K8X6wHGPtWrdA03eN-arGudv9xcoommUqkCSI_s
_aEFX4BgjoTKpQL1L6EKxY0npFa125G0Ls8NLB3Nb9vdCUPLQLH_Hl6SusgthUb9GAKUy
e7acG22NabAgOX1FKBmj4R40NjCxpm9krYkWvw5xzcDSn1ZXPcPdne6FwTTmpH6gpYOc
Kx7qEv9d6V_Y866yf6oziMCjAUpZDtBqmij0fc0iMSdVU2YKrPIB7EpnyaSCxmDHyPbX7lA
s8ZJ4jCyFCdqrLIyUy8JNo3HdlHG3J72OsXCfY40-r9hl4SDUCiOgawlGkBBUvQ5-1c1zUD9a
_jTsAoo--rL6L4uCa9ausRuzCPrmG-HHUt35ZPpKRyr9cjTnhRs8RcqiAUzkS6XWzPpxbphDs4
vrvxM3WbEmMonPzZ_-U8zYiRzf0E4f762gdSQXIZ0OLMu8qr5aZFsYQ7H-DfWgJY6cILDk
Am7lnFC2SErvqTn9I9RMm-q-4--7HSqLJ-4IY0TSJbzRGK9-Dy6SQHyq_u6SsF8QLFYT5iPed
QUOD5ZWTqT4fEhxkMTc4TaIv2diTGsKRQu27evQ3ggfQraGDcToHkgMxp-5fsI7yeYvGjkze
e5rFAQVd-i_Ahr9lQAsZCfDXdEjsNsBIA-ekH7rXG-tx_RPJgUFjy4Qi_yP39pWZRYWw_FV
G-U3_EK30CMemRWWVOuCkP_xfRy4hmW89_DTVxnEWYBlObWdGpCOqtFm_cdHhW2
ouNkrsr-U1n1Jamsd71OJS_nH5t6IWkj4rnW8GctPD9FJE7JC1391MN6Wc2LetTbVXNgN9cF
BEUlsHUUfzR6RPC52nE-xLtEZI2FoyPcNlZxwQ3nU0VdhfspWY354D1j_aZPujreC_pZmn4tv
kNweBEgfljCE8dHIB2fouQyeib5jbj6pBttPDKVSkF7OxlXa5pgOw9Q1JofYI3DH19xzvJMJY
h2Z0bqFmTBpXmZL0Ps2sv-PB2is2CQdAMrW4cNkbbB5b3jIVAxWUz1SuRVKS_Q_ZoEmh
SF_2jkTC32lYL-eYpaMQlWX7lpzoe1_7Zpud0wco6a3SIt1fwMYf3ZBkpcXTjU9uxKyScNlhe6
Ibf5wKpGeJu90ulM53zxXqR4dzhNtBXsU;
AjaxSessionKey=1KKUGx7mu3IumExWa1j3%2BYxLWVQxfKXHsrUNdq%2F9ZxrFSterQe1
kgOeQKdzltuDEXDONjKo0XqoqWZ5PBcAn2A%3D%3D; userid=10032003901CBA47;
MicrosoftApplicationsTelemetryDeviceId=abead5c6-e843-460b8f6b-5dba38b33860;OH.SID-b1
d4f105-b583-41c8-9589-3df12311003c;
PersonalizationCookie=Eq%2BozeootwvCsMIqxJNOXECmZx9y93XOMh9%2FGMvP7jmd7J
A5hlsRYiblk2VglYvNAlMMp3QufP2Dd0UdeZbsDcc46y8DGaeNeDMo6txbLu%2FrDvD4GB
T%2BucqHb2E0LlsgT%2FXD5vLbBYQhTWHCBhx5O9qKaapQkD6AgwhrBA3rCNv0E1rIS
whnuJ%2FYYMBe6JBIEmrkpe2s8t6dVk72d%2FeMRrUB6wa3TbwCzxJKDSQ42kJIZ7Y%2B
xzjIrczN4GH3KR9vp37UXUJZGpa9SCKI%2BYoYbSDkR3pOwcal%2FxVc6PhlrGBxH1E%2
FLLyCetFZwEEf%2BAEA;”,
  “ParameterCount”: 1,
  “Parameters”: [
  “workload”
  ],
  “Origin”: “”
  },
  “Response”: {
    “Headers”: “Cache-Control: no-store,no-cache\r\nPragma:
no-cache\r\nContent-Type: application/json; charset=utf-8\r\nVary:
Accept-Encoding\r\nRequest-Context: appId=\r\nStrict-Transport-Security:
max-age=31536000; includeSubDomains\r\nReferrer-Policy:
strict-origin-when-cross-origin\r\nX-Content-Type-Options:
nosniff\r\nX-Xss-Protection: 1; mode=block\r\nX-Frame-Options:
SAMEORIGIN\r\nX-Ua-Compatible: IE=edge,chrome=1\r\nNel:
{\“report_to\”:\“NelOfficeHubUpload1\”,\“max_age\”:3600,\“failure_fraction\”:1.0,\“success_fra
ction\”:0.01}\r\nReport-To:
{\“group\”:\“NelOfficeHubUpload1\”,\“max_age\”:3600,\“endpoints\”:[{\“url\”:\“https://officehu
b.nel.measure.office.net/api/report?tenantId=69cf39ba-a26e-45a3-98da-
501d69ac5df5&destinationEndpoint=weu&frontEnd=AFD\”}]}\r\nX-Cache:
CONFIG_NOCACHE\r\nX-Msedge-Ref: RefA: 1A8057EA53584FEAB7B86036B32D0F29
RefB: VIEEDGE4018 RefC: 2024-06-24T08:49:00Z\r\nDate: Mon, 24 Jun 2024 08:49:00
GMT”,
    “Body”:
“{\“Value”:{\“ConnectedExperience\”:{“State\”:true, “PolicyValue\”:0}, “SendFeedback\”:{\“St
ate\”:true,\“PolicyValue\”:0},\“ScreenShot\”:{\“State\”:false, \“PolicyValue\”:
0},\“EmailCollection\”:{\“State\”:false,\“PolicyValue\”:0},\“SendSurvey\”:{\“State\”:true,\“Polic
yValue\”:0},\“LogCollection\”:{\“State\”:false,\“PolicyValue\”:0}},\“PoliciesHash\”:null,\“LastU
pdated\”:\“2024-06-24T08:49:01.3193831Z\”,\“CheckInInterval\”:1440,\“Success\”:true,\“Requir
edAdminPolicies\”:[\“ConnectedExperience\”,\“SendFeedback\”,\“ScreenShot\”,\“EmailCollectio
n\”,\“LogCollection\”,\“SendSurvey\”]}”,
    “BodyLength”: 523,
    “hash”: “8cfa3488e444db9e959d6abeaab9511c60fbe2ae”,
    “Time”: “Jun 24, 2024, 10:49:01\u202fAM”,
    “Length”: 523,
    “Status”: 200,
    “StatusText”: “”,
    “ResponseHttpVersion”: “”
    “RTT”: 721,
    “Title”: “”
    “ContentType”: “application/json; charset=utf-8”,
    “InferredType”: “JSON”,
    “MimeType”: “JSON”,
    “HasSetCookies”: false,
    “Cookies”: [ ],
    “ReflectedParams”: [ ],
    “Reflections”: 0
  }
},
```

Embodiments of the dynamically generating payload schema processing code using a machine learning dynamic protocol parser 150 by applying a machine learning model to the data structure package 130, the payload schema processing code including a description of each field (description of each field 155) of the data structure package 130 and a parser function (e.g., python parser function 160) for extracting a prompt 180. Embodiments of the present technology include providing an output in response to the data structure package 130 (e.g., the uninterpreted JSON input). For example, an exemplary an output description in response to the uninterpreted JSON input according to some embodiments is included below.

```
{
“message”: {
“id”: “string”,
“author”: {
  “role”: “string”,
  “name”: “string or null”,
  “metadata”: { }
},
“create_time”: “timestamp or null”,
“update_time”: “timestamp or null”,
“content”: {
  “content_type”: “string”,
  “parts”: [“array of strings”]
},
“status”: “string”,
“end_turn”: “boolean or null”,
“weight”: “float”,
“metadata”: {
  “is_visually_hidden_from_conversation”: “boolean”,
  “request_id”: “string or null”,
  “message_source”: “string or null”,
  “timestamp_”: “string or null”,
  “message_type”: “string or null”,
  “model_slug”: “string or null”,
  “default_model_slug”: “string or null”,
  “parent_id”: “string or null”,
  “model_switcher_deny”: “array”,
  “citations”: “array”,
  “gizmo_id”: “string or null”,
  “pad”: “string or null”
},
“recipient”: “string”
},
“conversation_id”: “string”,
“error”: “null or object”
}
```

Embodiments of the present technology include an output parser function (e.g., python parser function 160). For example, the parser function for extracting a prompt 180. For example, a output python function (e.g., python parser function 160) according to some embodiments is shown below:

```
‘‘‘python
import json
# Split the data
packets = intercepted_data.split(′data: ′)[1:]
# Parse JSON and extract prompt and response
prompt = None
response = None
for packet in packets:
  json_obj = json.loads(packet)
  message = json_obj.get(″message″, { })
  author_role = message.get(″author″, { }).get(″role″)
  content_parts = message.get(″content″, { }).get(″parts″, [ ])
  if author_role == ″user″:
    prompt = content_parts[−1]
  elif author_role == ″assistant″ and message.get(″status″) ==
″finished_successfully″:
  response = content_parts[−1]
print(″Prompt:″, prompt)
print(″Response:″, response)
‘‘‘
```

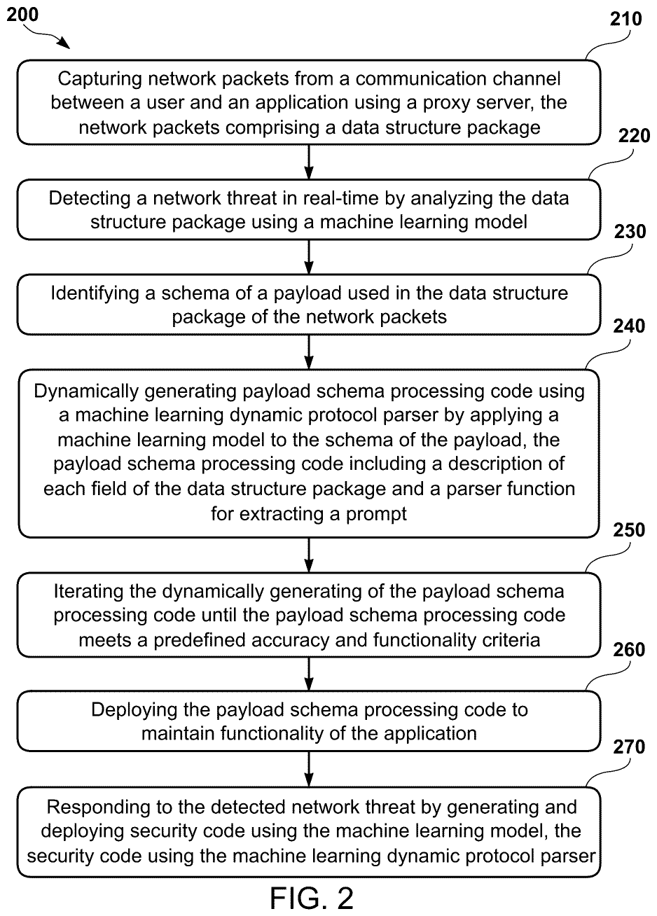

FIG. 2 depicts a process flow diagram for dynamically generating payload schema processing code using machine learning, according to embodiments of the present technology. FIG. 2 is a flowchart of an example computer-implemented method for dynamically generating payload schema processing code using machine learning, the method comprising the following steps. At step 210, capturing network packets from a communication channel between a user 105 and an application using a proxy server 110, the network packets comprising a data structure package 130. At step 220, detecting a network threat in real-time by analyzing the data structure package 130 using a machine learning model. At step 230, identifying a schema of a payload used in the data structure package 130 of the network packets. At step 240, dynamically generating payload schema processing code using a machine learning dynamic protocol parser 150 by applying a machine learning model to the schema of the payload, the payload schema processing code including a description of each field (e.g., description for each field 155) of the data structure package 130 and a parser function (e.g., python parser function 160) for extracting a prompt 180. At step 250, iterating the dynamically generating of the payload schema processing code until the payload schema processing code meets a predefined accuracy and functionality criteria. At step 270, responding to the detected network threat by generating and deploying security code using the machine learning model, the security code using the machine learning dynamic protocol parser 150.

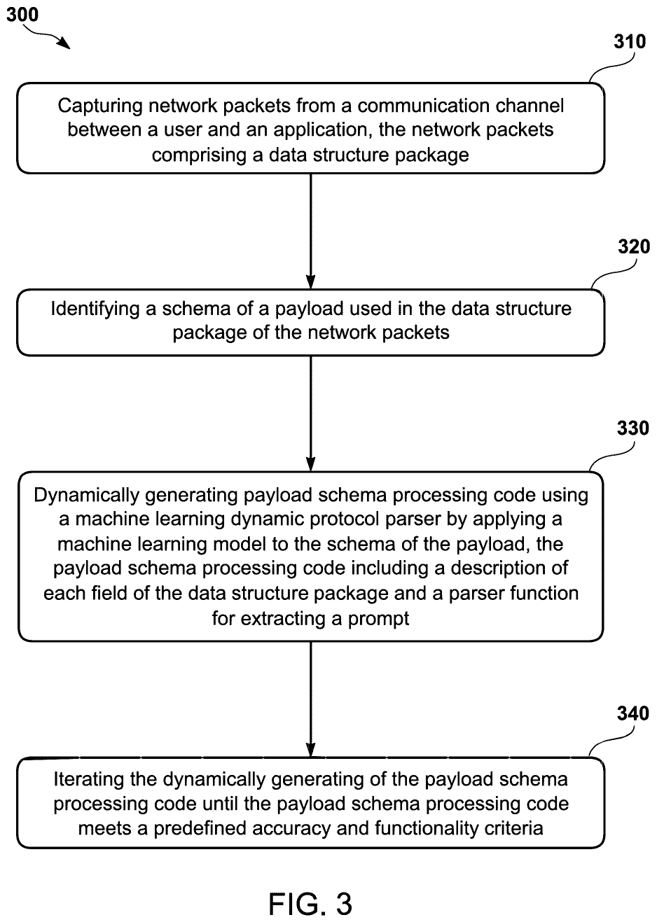

FIG. 3 depicts another process flow diagram for dynamically generating payload schema processing code using machine learning, according to embodiments of the present technology. FIG. 3 is An exemplary flowchart of an example method for a computer-implemented method for dynamically generating payload schema processing code using machine learning, the method comprising the following operations. At step 310, capturing network packets from a communication channel between a user 105 and an application, the network packets comprising a data structure package 130. At step 320, identifying a schema of a payload used in the data structure package 130 of the network packets. At step 330, dynamically generating payload schema processing code using a machine learning dynamic protocol parser 150 by applying a machine learning model to the schema of the payload, the payload schema processing code including a description of each field (e.g., description for each field 155) of the data structure package 130 and a parser function (e.g., python parser function 160) for extracting a prompt 180. At step 340, iterating the dynamically generating of the payload schema processing code until the payload schema processing code meets a predefined accuracy and functionality criteria.

Some embodiments of the present technology include a computer-implemented method for dynamically generating payload schema processing code using machine learning, the method comprising: capturing network packets from a communication channel between a user 105 and an application, the network packets comprising a data structure package 130; identifying a schema of a payload used in the data structure package 130 of the network packets; dynamically generating payload schema processing code using a machine learning dynamic protocol parser 150 by applying a machine learning model to the schema of the payload, the payload schema processing code including a description of each field (e.g., description for each field 155) of the data structure package 130 and a parser function (e.g., python parser function 160) for extracting a prompt 180; and iterating the dynamically generating of the payload schema processing code until the payload schema processing code meets a predefined accuracy and functionality criteria.

In some embodiments the capturing network packets comprises intercepting the network packets using a proxy server 110 positioned between the user 105 and the application, the application being an Large Language Model (LLM) integrated application using an external Application Programing Interfaces (API) provided by an LLM provider.

In some embodiments the proxy server 110 uses deep packet inspection (DPI) techniques to capture detailed information from the network packets.

In some embodiments the predefined accuracy and functionality criteria include successfully extracting the prompt 180 from the network packets.

In some embodiments the machine learning model is a large language model (LLM) trained to analyze the network packets and generate parser functions (e.g., python parser function 160).

In some embodiments the dynamically generating payload schema processing code using the machine learning dynamic protocol parser 150 comprises generating a plurality of fields (e.g., description for each field 155) of the data structure package 130 and a parser function (e.g., python parser function 160) for extracting the prompt 180.

In some embodiments the data structure package 130 is an uninterrupted input in JSON format.

In some embodiments the iterating the dynamically generating of the payload schema processing code until the payload schema processing code meets the predefined accuracy and functionality criteria is an iterative self-correction mechanism, the iterative self-correction mechanism refining the generated payload schema processing code until the prompt 180 is extracted.

In some embodiments the predefined accuracy and functionality criteria comprise correctly parsing and extracting specific fields (e.g., description for each field 155) from the data structure package 130.

In some embodiments the machine learning model uses natural language processing (NLP) techniques to analyze the data structure package 130 and generate the payload schema processing code.

In some embodiments the machine learning model is configured to detect zero-day vulnerabilities by training the machine learning model on previous known vulnerabilities and creating a separate offensive machine learning model that generates vulnerabilities that are used as synthetic training data.

In some embodiments the generated payload schema processing code is deployed in a sandbox environment for testing before being deployed.

In some embodiments the machine learning model generates an alert, the alert being when a network threat is detected.

Some embodiments further include testing the generated payload schema processing code against a set of known network packets to verify accuracy and functionality.

In some embodiments the machine learning model iteratively self-corrects the generated payload schema processing code based on feedback from testing results.

Some embodiments further include detecting a network threat in real-time by analyzing the data structure package 130 using a machine learning model.

Some embodiments further include responding to the detected network threat by generating and deploying security code using the machine learning model, the security code using the machine learning dynamic protocol parser 150.

Some embodiments of the present technology include a computer-implemented method for dynamically generating payload schema processing code using machine learning, the method comprising: capturing network packets from a communication channel between a user 105 and an application, the network packets comprising a data structure package 130; identifying a schema of a payload used in the data structure package 130 of the network packets; dynamically generating payload schema processing code using a machine learning dynamic protocol parser 150 by applying a machine learning model to the schema of the payload, the payload schema processing code including a description of each field (e.g., description for each field 155) of the data structure package 130 and a parser function (e.g., python parser function 160) for extracting a prompt 180; and iterating the dynamically generating of the payload schema processing code until the payload schema processing code meets a predefined accuracy and functionality criteria, the predefined accuracy and functionality criteria include successfully extracting the prompt 180 from the network packets.

Some embodiments of the present technology include a computer-implemented method for dynamically generating payload schema processing code using machine learning, the method comprising: receiving network packets using a proxy server 110 between external Application Programing Interface (API) of a Large Language Model (LLM) integrated application and a prompt filter, the network packets comprising a data structure package 130; receiving a failure response from a predefined static protocol parser 120, the predefined static protocol parser 120 generating the failure response after failing to process the data structure package 130; dynamically generating payload schema processing code using a machine learning dynamic protocol parser 150 by applying a machine learning model to the data structure package 130, the payload schema processing code including a description of each field (e.g., description for each field 155) of the data structure package 130 and a parser function (e.g., python parser function 160) for extracting a prompt 180; iterating the dynamically generating of the payload schema processing code using the machine learning dynamic protocol parser 150 until the payload schema processing code meets a predefined accuracy and functionality criteria, the predefined accuracy and functionality criteria comprising successfully extracting the prompt 180 from the network packets; and deploying the payload schema processing code to maintain functionality of the LLM integrated application.

In some embodiments the machine learning model iteratively self-corrects the generated payload schema processing code based on feedback from testing results.

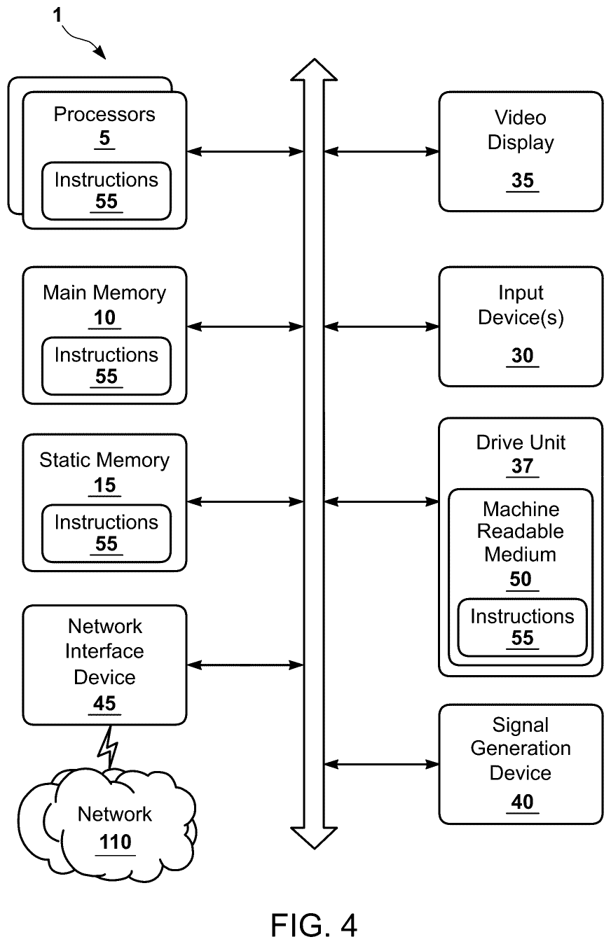

FIG. 4 illustrates an exemplary computer system that may be used to implement security methods for dynamically generating payload schema processing code using machine learning, according to embodiments of the present technology. FIG. 4 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof, the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

Thus, the technology of security methods and systems for dynamically generating payload schema processing code using machine learning is disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed:

1. A computer-implemented method for dynamically generating payload schema processing code using machine learning, the method comprising:
capturing network packets from a communication channel between a user and an application, the network packets comprising a data structure package;
identifying a schema of a payload used in the data structure package of the network packets;
dynamically generating payload schema processing code using a machine learning dynamic protocol parser by applying a machine learning model to the schema of the payload, the payload schema processing code including a description of each field of the data structure package and a parser function for extracting a prompt; and
iterating the dynamically generating of the payload schema processing code until the payload schema processing code meets a predefined accuracy and functionality criteria.

2. The computer-implemented method of claim 1, wherein the capturing network packets comprises intercepting the network packets using a proxy server positioned between the user and the application, the application being an Large Language Model (LLM) integrated application using an external Application Programing Interfaces (API) provided by an LLM provider.

3. The computer-implemented method of claim 2, wherein the proxy server uses deep packet inspection (DPI) techniques to capture detailed information from the network packets.

4. The computer-implemented method of claim 1, wherein the predefined accuracy and functionality criteria include successfully extracting the prompt from the network packets.

5. The computer-implemented method of claim 1, wherein the machine learning model is a large language model (LLM) trained to analyze the network packets and generate parser functions.

6. The computer-implemented method of claim 1, wherein the dynamically generating payload schema processing code using the machine learning dynamic protocol parser comprises generating a plurality of fields of the data structure package and a parser function for extracting the prompt.

7. The computer-implemented method of claim 1, wherein the data structure package is an uninterrupted input in JSON format.

8. The computer-implemented method of claim 1, wherein the iterating the dynamically generating of the payload schema processing code until the payload schema processing code meets the predefined accuracy and functionality criteria is an iterative self-correction mechanism, the iterative self-correction mechanism refining the generated payload schema processing code until the prompt is extracted.

9. The computer-implemented method of claim 8, wherein the predefined accuracy and functionality criteria comprise correctly parsing and extracting specific fields from the data structure package.

10. The computer-implemented method of claim 1, wherein the machine learning model uses natural language processing (NLP) techniques to analyze the data structure package and generate the payload schema processing code.

11. The computer-implemented method of claim 1, wherein the machine learning model is configured to detect zero-day vulnerabilities by training the machine learning model on previous known vulnerabilities and creating a separate offensive machine learning model that generates vulnerabilities that are used as synthetic training data.

12. The computer-implemented method of claim 1, wherein the generated payload schema processing code is deployed in a sandbox environment for testing before being deployed.

13. The computer-implemented method of claim 1, wherein the machine learning model generates an alert, the alert being when a network threat is detected.

14. The computer-implemented method of claim 1, further comprising testing the generated payload schema processing code against a set of known network packets to verify accuracy and functionality.

15. The computer-implemented method of claim 14, wherein the machine learning model iteratively self-corrects the generated payload schema processing code based on feedback from testing results.

16. The computer-implemented method of claim 1, further comprising detecting a network threat in real-time by analyzing the data structure package using a machine learning model.

17. The computer-implemented method of claim 16, further comprising responding to the detected network threat by generating and deploying security code using the machine learning model, the security code using the machine learning dynamic protocol parser.

18. A computer-implemented method for dynamically generating payload schema processing code using machine learning, the method comprising:
capturing network packets from a communication channel between a user and an application, the network packets comprising a data structure package;
identifying a schema of a payload used in the data structure package of the network packets;
dynamically generating payload schema processing code using a machine learning dynamic protocol parser by applying a machine learning model to the schema of the payload, the payload schema processing code including a description of each field of the data structure package and a parser function for extracting a prompt; and
iterating the dynamically generating of the payload schema processing code until the payload schema processing code meets a predefined accuracy and functionality criteria, the predefined accuracy and functionality criteria include successfully extracting the prompt from the network packets.

19. A computer-implemented method for dynamically generating payload schema processing code using machine learning, the method comprising:
receiving network packets using a proxy server between external Application Programing Interface (API) of a Large Language Model (LLM) integrated application and a prompt filter, the network packets comprising a data structure package;
receiving a failure response from a predefined static protocol parser, the predefined static protocol parser generating the failure response after failing to process the data structure package;
dynamically generating payload schema processing code using a machine learning dynamic protocol parser by applying a machine learning model to the data structure package, the payload schema processing code including a description of each field of the data structure package and a parser function for extracting a prompt;
iterating the dynamically generating of the payload schema processing code using the machine learning dynamic protocol parser until the payload schema processing code meets a predefined accuracy and functionality criteria, the predefined accuracy and functionality criteria comprising successfully extracting the prompt from the network packets; and
deploying the payload schema processing code to maintain functionality of the LLM integrated application.

20. The computer-implemented method of claim 19, wherein the machine learning model iteratively self-corrects the generated payload schema processing code based on feedback from testing results.
